(19) United States
(12) Patent Application Publication
(10) Pub. No.: US 2026/0104487 A1
(43) Pub. Date: Apr. 16, 2026

(54) SCALING RADAR-CAMERA LEARNING VIA GEOMETRIC PRIORS

(71) Applicant: RADAREYE Ltd., London (GB)

(72) Inventor: Mohammed Alloulah, Letchworth Garden City (GB)

(73) Assignee: RADAREYE Ltd., London, GB (GB)

(21) Appl. No.: 19/354,277

(22) Filed: Oct. 9, 2025

Related U.S. Application Data
(60) Provisional application No. 63/707,654, filed on Oct. 15, 2024.

(51) Int. Cl. G01S 7/40; G01S 13/58; G01S 13/86; G01S 13/89; G06T 7/80

(52) U.S. Cl. CPC G01S 7/4052; G01S 13/584; G01S 13/867; G01S 13/89; G06T 7/80; G06T 2207/20081; G06T 2207/20084; G06T 2207/30244

(57) ABSTRACT

Methods, systems, and apparatus, including computer programs encoded on computer storage media, for calibrating a cross-modal radar-camera rig in order to parametrise a neural network perception model with geometric priors. For example, the disclosed invention describes a method for (1) receiving a plurality of data entries generated by a radar-camera rig including radar point clouds and camera images corresponding to a scene within which a calibration 3-D structure is present, (2) inputting the data entries into a calibration procedure for estimating the geometric relationship of the radar and camera devices within the rig, (3) inputting the estimated geometric information along with the data entries into a machine learning model, and (4) training the machine learning model based on a training dataset along with geometric information to generate a trained machine learning model that iteratively learns to solve a perception or pretext task. The trained model may further be frozen and deployed in an environment that has groundtruth landmarks which enable further finetuning of the estimated geometric information in order to further enhance the perception performance of the deployed model.

### CROSS-REFERENCE TO RELATED APPLICATIONS

This patent claims priority to U.S. Provisional Application 63/707,654, entitled Scaling radar-camera learning via geometric priors, filed Oct. 15, 2024, which is hereby incorporated by reference.

### PRIOR ART

R Hartley, A Zisserman. Multiple view geometry in computer vision. Cambridge university press; 2003.
A Dosovitskiy et al. An image is worth 16×16 words: Transformers for image recognition at scale. arXiv preprint arXiv: 2010.11929. 2020.
W Yifan, C Doersch, R Arandjelović, J Carreira, A Zisserman. Input-level inductive biases for 3D reconstruction. CVPR 2022.
V Guizilini, I Vasiljevic, D Chen, R Ambrus, A Gaidon. Towards zero-shot scale-aware monocular depth estimation. CVPR 2023.
F Bartoccioni, É Zablocki, A Bursuc, P Pérez, M Cord, K Alahari. Lara: Latents and rays for multi-camera bird's-eye-view semantic segmentation. CoRL 2023.
M Alloulah, Z Radivojevic, R Mayrhofer, H Huang. Kinphy: a kinetic in-band channel for millimetre-wave networks. SenSys 2019.
M Alloulah, inventor; Radareye LTD, assignee. Self-supervised multi-representation learning for radar-camera data. United States provisional patent application U.S. 63/661,642. 2024 Jun. 19.
M Alloulah, inventor; Radareye LTD, assignee. Learning spatiotemporal radar attention via visual tracking priors. United States provisional patent application U.S. 63/687,835. 2024 Aug. 28.

### BACKGROUND OF THE INVENTION

Radar is an important enabler of robust perception for advanced driver-assistance systems (ADAS) or full self-driving. Radar uses radio frequency (RF) signals that are uniquely able to propagate through bad weather conditions such as snow and fog, or dust particles from pollution such as smog. As such, radar is a sensing modality that may support robust perception under challenging visibility conditions when other visual modalities such as camera and lidar (light detection and ranging) fail.

Multimodal machine learning is used to fuse radar data with other visual modalities such as camera images. For example, the fusion of camera and radar data allows a system to continue to perceive the environment under bad visibility conditions such as snowstorms or smog. This is because a fusion perception system would be able to adjust its operation to rely on radar signals more when optical perception degrades.

Radar can also support privacy-preserving perception. This is because radar signals perceive the environment which may include people without capturing their private information such as their facial features and exact bodily shapes. Camera-radar fusion for privacy-preserving perception would disable information from the input camera stream altogether and only rely on radar information. Under such settings, camera-radar fusion is needed only during the training phase, while relying on standalone radar signals during the inference stage. Applications are wide-ranging, for example elder care, building analytics, and security monitoring.

In order to support the aforementioned perception applications, it is desirable to devise data-driven methods that can scale irrespective of the exact camera-radar rig geometry used when collecting data. This is because naively aggregating portions of data from different camera-radar rig geometries as a training dataset may not be sufficient for generalisation (e.g., zero-shot, or few-shot) to unseen geometries. Specifically, it is unlikely that such naive data aggregation would promote learning to disentangle the influence of rig geometries from the modelling of the core end-to-end perception functionality. Moreover, it would be restrictive to enforce consistency by prescribing an exact rig geometry for collecting training data and for deployments. For example, different vehicles have different geometries and sensor placements, and it is common practice to assume a finetuning stage on labels collected from the final deployment in order to adjust for these geometric disparities. The methods disclosed in this invention mitigate some of these shortcomings by means of a novel calibration technique for the camera-radar rig whose estimates are injected into the perception model during training and inference as geometric priors. These geometric priors condition the perception model and as such make it in-situ parametrisable, which ultimately enhances data scalability across deployment scenarios.

### SUMMARY OF THE INVENTION

In accordance with some example embodiments, a cross-modal radar-camera machine learning system for perception uses a rig of radar and camera devices.

In accordance with some example embodiments, the radar-camera rig is calibrated by estimating geometric information that precisely relates the radar perception frame to the camera perception frame within their overlapped fields of view (FOVs)

In accordance with some example embodiments, the cross-modal calibration procedure consists of two separate procedures for radar and camera that are combined in order to establish radar-camera correspondences with the joint FOV.

In accordance with some example embodiments, the cross-modal calibration procedure uses a 3-D structure of known geometry which is tagged simultaneously with radar tags and camera tags.

In accordance with some example embodiments, the radar tags are coded meta-surfaces that can be interrogated in space and across time wirelessly by the radar.

In accordance with some example embodiments, the coded meta-surfaces use impedance modulation of their antennae that are driven by codes unique to each tag.

In accordance with some example embodiments, the coded meta-surfaces may be further mounted onto polyhedral structures for enhanced omnidirectional reflectivity.

In accordance with some example embodiments, the camera tags are fiducial markers attached to the 3-D structure of known geometry.

In accordance with some example embodiments, the radar estimates the 3-D locations of each meta-surface tag of the 3-D structure of known geometry.

In accordance with some example embodiments, the camera detects the fiducial markers and estimates their pixel coordinates on the image.

In accordance with some example embodiments, the procedure establishes radar-camera correspondence based on the separate radar and camera estimates.

In accordance with some example embodiments, the procedure uses the correspondences to estimate the translation vector and rotation matrix that relate the camera and radar measurement frames within 3-D world coordinates.

In accordance with some example embodiments, the estimated entities including the translation vector and rotation matrix are collectively denoted as geometric priors.

In accordance with some example embodiments, the geometric priors from the calibration procedure are fed to a neural network model during training alongside the paired radar-camera data.

In accordance with some example embodiments, the neural network model becomes conditioned on the geometric priors and as such becomes geometry-aware.

In accordance with some example embodiments, the neural network is frozen after training in order to finetune the geometric priors using groundtruth geometric measurements.

In accordance with some example embodiments, the neural network model is deployed with the finetuned geometric priors.

### BRIEF DESCRIPTION OF DRAWINGS

FIG. 1 illustrates the multi-view geometry of a cross-modal radar-camera rig with overlapped FOV.

FIG. 2 illustrates the epipolar plane formed by the reference frames of radar and camera and a point from the scene being observed by the two devices.

FIG. 3 depicts a 3-D object of known geometry with meta-surface tags attached to its sides and corners whose radio responses are being interrogated wireless by a remote radar in order to estimate their locations within the radar's frame.

FIG. 4 depicts alternative meta-surface tag geometries for enhanced omnidirectional reflectivity.

FIG. 5 depicts the object of known geometry captured in the camera 2-D projection frame with one corresponding meta-surface tag location being estimated in the camera frame.

FIG. 6 illustrates how the geometric information computed by the cross-modal calibration procedure may be turned into geometric embeddings that are fed to a geometry-aware transformer model.

FIG. 7 shows a system-level procedure for incorporating the cross-modal geometric calibrations into a machine learning model for training and then for inference after deployment.

FIG. 8 lists the steps that the cross-modal calibration procedure performs for computing estimates of the mathematical entities that describe the geometric relationship between the radar and camera devices.

### DETAILED DESCRIPTION

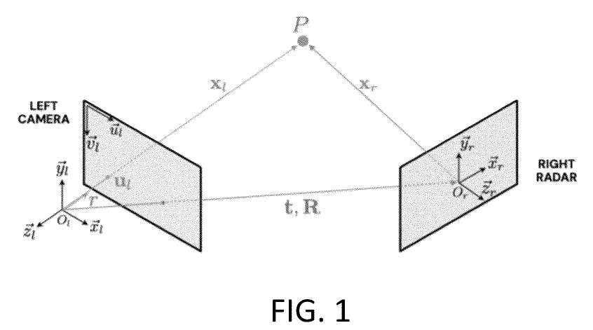

FIG. 1 shows a model of a radar-camera system for cross-modal learning. Using a pinhole model, a left camera views scene point P with 3-D coordinates XI in the left camera frame and with projected image coordinates uₗ in 2-D. The radar on the right perceives point P using its antenna array as vector xᵣ, with a coordinate frame originating from its surface. Although xᵣ is usually measured in polar coordinates (azimuth, elevation, and range) using the physics of radar perception, we will assume for simplicity it can be readily converted to a Cartesian coordinate frame for the antenna array of the radar as depicted in FIG. 1. Note also that while it is valid to conceptually think of the radio beams (received and/or transmitted) as originating from the surface of the antenna array, in reality the physics of radio waves are more involved and are fundamentally governed by the precise phases and amplitudes of all individual antennae that make up the overall radar antenna array. Without loss of generality as shown in FIG. 1, the camera frame can be related to the radar frame by translation vector t∈ [symbol] ³ and rotation matrix R∈ [symbol] ^{3×3}.

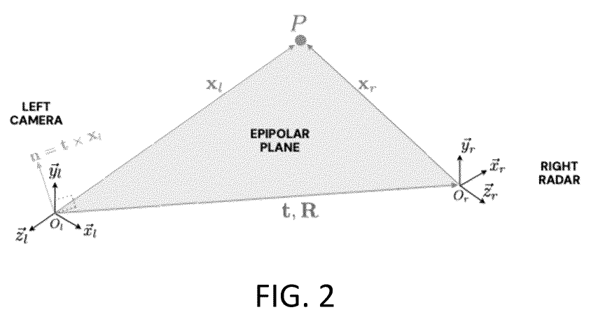

FIG. 2 describes the Epipolar geometry of the radar-camera system. Specifically, the scene point P, the left camera origin Oₗ, and the right radar origin Oᵣ form a so-called epipolar plane. A unique epipolar plane can be formed for every point captured simultaneously by the camera and radar in the scene. Using the epipolar plane, we can write the epipolar constraint that allows us to estimate the translation vector t and rotation matrix R. The estimation procedure is derived as follows.

Referring to FIG. 2 again, the epipolar plane can be mathematically described as a cross product between xₗ and t, which results in a vector normal to the epipolar plane n=t×xₗ. The epipolar constraint is then obtained by noting that xₗ and n are perpendicular vectors and hence their dot product should be zero xₗ·(t×xₗ)=0. In matrix form, the epipolar constraint can be written as

$${x}_{l} \cdot ( t \times {x}_{l} ) = 0$$

$$[ {x}_{l} {y}_{l} {z}_{l} ] [ \begin{matrix}{t}_{y} {z}_{l} - {t}_{z} {y}_{l} \\ {t}_{z} {x}_{l} - {t}_{x} {z}_{l} \\ {t}_{x} {y}_{l} - {t}_{y} {x}_{l}\end{matrix} ] = 0$$

$$[ {x}_{l} {y}_{l} {z}_{l} ] [ \begin{matrix}0 & - {t}_{z} & {t}_{y} \\ {t}_{z} & 0 & - {t}_{x} \\ - {t}_{y} & {t}_{x} & 0\end{matrix} ] [ \begin{matrix}{x}_{l} \\ {y}_{l} \\ {z}_{l}\end{matrix} ] = 0$$

Noting that we can express xₗ in terms of xᵣ using the translation vector t and rotation matrix R, we can write

$${x}_{l} = R {x}_{r} + t$$

$$[ \begin{matrix}{x}_{l} \\ {y}_{l} \\ {z}_{l}\end{matrix} ] = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}{x}_{r} \\ {y}_{r} \\ {z}_{r}\end{matrix} ] + [ \begin{matrix}{t}_{x} \\ {t}_{y} \\ {t}_{z}\end{matrix} ]$$

Substituting into the epipolar constraint

$$[ {x}_{l} {y}_{l} {z}_{l} ] [ \begin{matrix}0 & - {t}_{z} & {t}_{y} \\ {t}_{z} & 0 & - {t}_{x} \\ - {t}_{y} & {t}_{x} & 0\end{matrix} ] ( [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}{x}_{r} \\ {y}_{r} \\ {z}_{r}\end{matrix} ] + [ \begin{matrix}{t}_{x} \\ {t}_{y} \\ {t}_{z}\end{matrix} ] ) = 0$$

$$[ {x}_{l} {y}_{l} {z}_{l} ] [ \begin{matrix}0 & - {t}_{z} & {t}_{y} \\ {t}_{z} & 0 & - {t}_{x} \\ - {t}_{y} & {t}_{x} & 0\end{matrix} ] [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] [ \begin{matrix}{x}_{r} \\ {y}_{r} \\ {z}_{r}\end{matrix} ] = 0$$

$$[ {x}_{l} {y}_{t} {z}_{l} ] [ \begin{matrix}{e}_{11} & {e}_{12} & {e}_{13} \\ {e}_{21} & {e}_{22} & {e}_{23} \\ {e}_{31} & {e}_{32} & {e}_{33}\end{matrix} ] [ \begin{matrix}{x}_{r} \\ {y}_{r} \\ {z}_{r}\end{matrix} ] = 0$$

$${x}_{l}^{⊤} E {x}_{r} = 0$$

This expression relates the 3-D position of scene point P captured by the left camera to that captured by the right radar through the essential matrix E=TR, where we have made use of the cross product matrix T∈ [symbol] ^{3×3}. However, a monocular camera cannot hope to estimate the 3-D position of the scene point P. Therefore, the 3-D position is replaced with the projected 2-D image uₗ in the so-called homogeneous coordinates according to (see FIG. 1)

$${z}_{l} [ \begin{matrix}{u}_{l} \\ {v}_{i} \\ 1\end{matrix} ] = [ \begin{matrix}{f}_{l}^{x} & 0 & {o}_{l}^{x} \\ 0 & {f}_{l}^{y} & {o}_{l}^{y} \\ 0 & 0 & 1\end{matrix} ] [ \begin{matrix}{x}_{l} \\ {y}_{l} \\ {z}_{l}\end{matrix} ]$$

$${z}_{l} {u}_{l} = {K}_{l} {x}_{l}$$

$${x}_{l}^{⊤} = {z}_{l} {u}_{l}^{⊤} {K}_{l}^{- {1}^{⊤}}$$

where we used homogeneous coordinates, Kₗ∈ [symbol] ^{3×3} is the left camera intrinsic calibration matrix, and zₗ is its unknown depth. The camera intrinsic matrix is either immediately available as meta data in the image or can be estimated by off-the-shelf calibration methods Yifan et al. (2022). On the other hand, the right radar can readily estimate the 3-D position of scene point P in its field of view (FOV) as \hat{x}ᵣ. Plugging back estimates ûₗ and \hat{x}ᵣ into the epipolar constraint yields

$${x}_{l}^{⊤} E {x}_{r} = 0$$

$${z}_{l} {\hat{u}}_{l}^{⊤} {K}_{l}^{- {1}^{⊤}} E {\hat{x}}_{r} = 0$$

$${\hat{u}}_{l}^{⊤} {K}_{l}^{- {1}^{⊤}} E {\hat{x}}_{r} = 0$$

because depth zₗ≠0. Define the cross-modal coupling matrix

$$W = {K}_{l}^{- {1}^{⊤}} E ,$$

the final epipolar constraint becomes

$${\hat{u}}_{l}^{⊤} W {\hat{x}}_{r} = 0$$

$$with E = {K}_{l}^{⊤} W and E = TR .$$

In order to compute the cross-modal coupling from camera and radar measurements, we rearrange the epipolar constraint as a system of linear equations of the form Aw=0, and solve for the vectorised coupling Hartley et al. (2003)

$${min}_{w} {w}^{⊤} {A}^{⊤} Aw s . t . {w}^{⊤} w = 1$$

Once W is solved for, DE can be easily computed. Further, the special structures of T and R matrices allow us to decompose DE using singular value decomposition (SVD) and readily arrive at the translation vector t and the rotation matrix R according to

$$t , R = SVD ( E )$$

So far, we discussed how the epipolar constraint from stereo vision can be adapted for cross-modal radar-camera perception. Within our new cross-modal formulation, we assumed that ûₗ and \hat{x}ᵣ are known in order to estimate the translation vector t and the rotation matrix R that relate the camera and radar geometries (i.e., frames). We next disclose a radar-camera calibration procedure that enables us to precisely measure ûₗ and \hat{x}ᵣ for a sparse set of points on the 3-D structure of known geometry. This sparse set is what would enable us to establish radar-camera correspondence for estimating t and R.

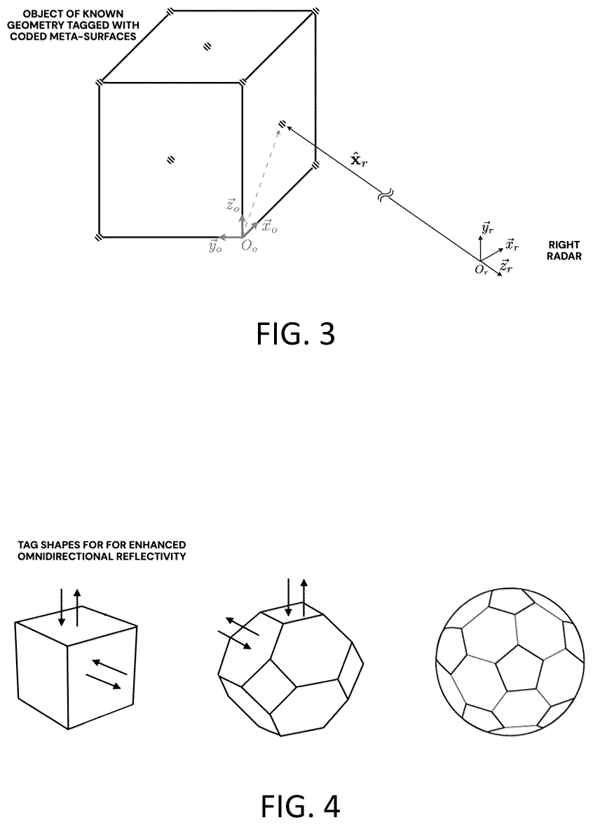

To measure \hat{x}ᵣ, we utilise coded meta-surfaces for uniquely interrogating the fine-grained reflectivity of a known 3-D structure in space and across time. FIG. 3 shows a cuboid structure tagged at the corners and centres of its faces. Each tag is a passive electromagnetic antenna that is further coded with a unique space-time code (or time-only). The code enables a radar to pinpoint where the 3-D coordinates of the tag \hat{x}ᵣ are in the radar's frame.

In some example embodiments, the tag is based on radio frequency (RF) backscatter principles wherein an electronic circuit modulates the impedance of a passive antenna. The modulation pattern may be set according to a code division multiple access (CDMA) signalling scheme. By making the CDMA code arbitrarily long, detection and localisation of the backscatter tag can be achieved at long distances and suboptimal orientations Alloulah et al. (2019), because the coding gain overcomes low SNR challenges.

In some example embodiments, it may be desirable to construct a more elaborate 3-D shape for each tag in order to further enhance the omnidirectional reflectivity of the tag irrespective of the location and orientation of the larger 3-D structure of known geometry. To this end, FIG. 4 depicts a few example tags of 3-D shapes with varying complexity from cubic to polyhedral structures.

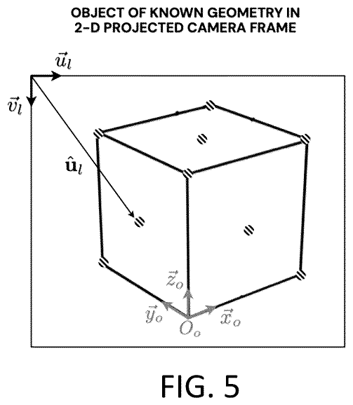

To measure ûₗ, we establish pixel coordinate correspondences with the tag locations on the 3-D structure in the camera frame. This process may make full use of the known geometry of the 3-D structure, the unique codes of the backscatter tags, and/or visual features on the 3-D structure such as colours and patterns. The visual features may further utilise fiducial markers if so desired for establishing radar-camera correspondences robustly. In addition, this process may either be performed manually by hand (e.g., a person annotates the image) or automatically using a suitable image processing algorithm (e.g., template matching against fiducial markers). An example pixel coordinate vector of one tag in the image frame is shown in FIG. 5. For clarity, FIG. 5 does not show visual fiducial markers.

In some example embodiments, care is taken while designing the shape of the 3-D structure of known geometry, as well as while designing the placement of its radar and vision tags. This is because the resultant 3-D coordinates measured by the radar along with their error characteristics may have a bearing on the system of linear equations in the epipolar constraint. In turn, these will affect the optimisation problem when solving for the translation vector t and the rotation matrix R. That is, there exists 3-D structures and tag placement geometries that would make the system of linear equations more amenable to numerical optimisation and more robust to real-world measurement errors.

Once a set of corresponding tag locations are measured in the camera and radar frames, E can then be computed and the translation vector t and the rotation matrix R can be finally obtained as described earlier.

With t and R computed, referring to FIG. 1, we can relate the left camera origin to the right radar frame as Oₗ=−R⁻¹t Yifan et al. (2022). Without loss of generality, we have assumed that the right radar is the world's coordinate frame. The overall camera projection that relates pixels to the world frame (in homogeneous coordinates) is P=Kₗ[R|t], and

$$[ \begin{matrix}{u}_{l} \\ {v}_{1} \\ 1\end{matrix} ] = {u}_{l} = P {x}_{r}$$

With the camera origin and projection defined in the world coordinate frame (again here without loss of generality the radar's), we can further define a viewing ray vector for each pixel in any jth camera according to

$${O}_{j} = - {R}_{j}^{- 1} {t}_{j}$$

$${r}^{( i )} = {( {K}_{j} {R}_{j} )}^{- 1} [ \begin{matrix}{u}_{j}^{( i )} \\ {v}_{j}^{( i )} \\ 1\end{matrix} ] , 1 \leq i \leq HW \qquad ( 2 )$$

Equations (1) and (2) describe the camera-radar rig in terms of intrinsic and extrinsic matrices that fully parametrise the multi-view geometry of the cross-modal system. As such, Equations (1) and (2) together act as a powerful inductive bias (or prior) that would allow a learning system to better reason about the geometry of the scene. This in turn allows us to scale the training corpora with data captured from many different camera-radar rig configurations without hampering generalisation or prescribing a rigid restrictive configuration for deployment.

In line with practice from prior art (e.g., Guizilini et al. (2023) and Bartoccioni et al. (2023)), Oⱼ and r⁽ⁱ⁾ are further normalised and encoded as high-dimensional embeddings using a Fourier mapping. The Fourier embeddings of Oⱼ and r⁽ⁱ⁾ are more suitable for a neural network to ingest. For flexibility, the Fourier embeddings are generated using separate numbers of frequency bands N_{F}_{_{O}} and N_{F}_{ᵣ} and sampling rates F_{O} and Fᵣ, respectively for Oⱼ and r⁽ⁱ⁾.

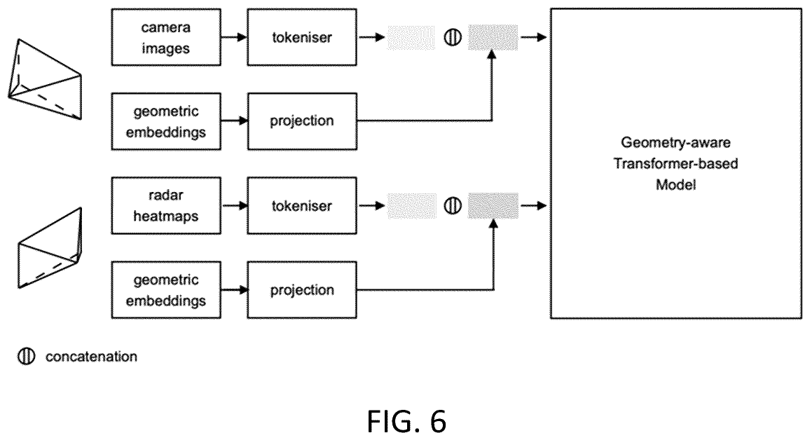

Now that our geometric priors Oⱼ and r⁽ⁱ⁾ are computed, FIG. 6 illustrates one neural network embodiment for utilising these priors alongside the paired camera and radar data. Specifically, a common practice in literature is to concatenate geometric embeddings with data embeddings channel-wise and feed the combined stream into a transformer-based model Dosovitskiy et al. (2020) or a variant thereof Yifan et al. (2022). Doing so makes the transformer model geometry-aware on a per-pixel basis. Not shown in FIG. 6, Oⱼ and r⁽ⁱ⁾ may further be utilised within the transformer model in order to query the latent space geometrically.

The neural network is trained based on a dataset of data entries and the geometric embeddings to iteratively learn using a loss function. Suitable loss functions include contrastive loss, reconstruction loss, cross-entropy loss, or the like, as detailed further in co-pending patent applications 19,243,105, entitled SELF-SUPERVISED MULTI-REPRESENTATION LEARNING FOR RADAR-CAMERA DATA, filed Jun. 19, 2025, and Ser. No. 19/353,449, entitled LEARNING SPATIOTEMPORAL RADAR ATTENTION VIA VISUAL TRACKING PRIORS, filed Oct. 8, 2025, which are hereby incorporated by reference. The teachings of these prior applications may be combined with the teachings of this specification in various ways to implement embodiments, including training methods, network models trained by those methods, and applications of these network models, such as advanced driver-assistance systems (ADAS) or full self-driving.

Once the transformer-based model has been trained, it may further be frozen in order to finetune the geometric priors for deployment. This is achieved by (1) deploying a radar-camera rig under possibly unseen geometric configuration, (2) estimating new geometric information using the procedure disclosed herein, (3) feeding them alongside paired radar and camera data in-situ with known scene groundtruth, (4) running inference with the model, (5) measuring deviation from known groundtruth, (6) adjusting the geometric information slightly (i.e. finetuning them) until the inference matches exactly or as close as possible the known groundtruth.

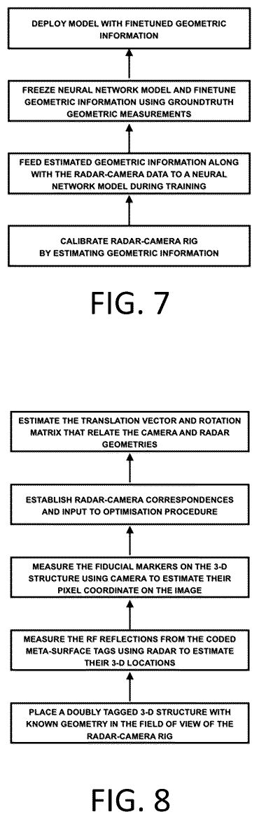

FIG. 7 summarises a procedure for an example system embodiment. The procedure makes use of the ideas disclosed in this invention in order to deploy a radar-camera perception system with geometric parametrisations that maximally optimise the performance of perception in-situ.

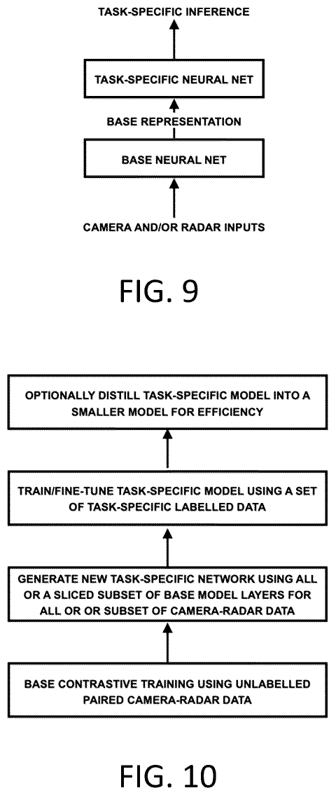

FIG. 8 summarises the calibration procedure disclosed in this invention that allows for estimating the translation and rotation of the camera w.r.t. the radar within the cross-modal radar-camera rig.

The example embodiment disclosed in this invention treats a pair of one radar and one camera devices. Another embodiment may incorporate multiple radars and/or multiple cameras. The methods and techniques disclosed may be extended for a plurality of cross-modal devices.

The description and drawings merely illustrate the principles of exemplary embodiments. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of exemplary embodiments and the concepts contributed by the inventor(s) to furthering the art, and are to be construed as being without limitation to such specifically recited examples and conditions. Moreover, all statements herein reciting principles, aspects, and embodiments, as well as specific examples thereof, are intended to encompass equivalents thereof.

It should be appreciated by those skilled in the art that any block diagrams herein represent conceptual views of illustrative software code or circuitry embodying exemplary embodiments. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

A person of skill in the art would readily recognise that steps of various above-described methods can be performed and/or controlled by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

1. A method, comprising:
a radar-camera rig;
receiving by a computing subsystem data entries from radar and camera in the radar-camera rig;
calibrating the radar-camera rig using a 3-D structure that enables estimating geometric information that describes position and orientation of one device with respect to the other;
calculating geometric embeddings based on the estimated geometric information;
feeding the data entries received along with the geometric embeddings to a neural network;
training the neural network based on a dataset of data entries and the geometric embeddings to iteratively learn using a loss function;
freezing the neural network and deploying the neural network for perception inferences;
obtaining perception groundtruth in-situ after deployment;
performing inferences and measuring deviation from groundtruth; and
finely adjusting the geometric information and in turn the geometric embeddings to give perception inferences that more closely match groundtruth, thereby enhancing the performance of the neural network.

2. The method of claim 1, wherein the 3D structure for calibration comprises coded radio frequency (RF) meta-surface tags that are interrogated by radar.

3. The method of claim 1, wherein the 3D structure has a known geometry.

4. The method of claim 1, wherein the 3D structure comprises visual tags that are detected by camera in order to directly or indirectly estimate the pixel coordinates of the meta-surface tags in the image domain.

5. The method of claim 1, wherein the tagged 3D structure is used to establish sparse radar-camera correspondences for estimating the translation and rotation of one device with respect to the other within the cross-modal rig.

6. The method of claim 1, wherein the coding of meta-surface tags within the 3D structure is unique per tag and happens in space and across time.

7. The method of claim 1, wherein the meta-surface tags may further be mounted on substructures for enhancing the omnidirectional reflectivity of the overall 3-D structure.

8. A method of claim 1, wherein the neural network is a transformer-based model or a variant thereof incorporating self- and cross-attention layers.

9. A method of claim 1, wherein the neural network may further use the geometric information estimated during the calibration stage to query a latent space within it.

10. A method of claim 1, wherein the neural network, a subset thereof, or a superset thereof are either pretrained without labels using a self-supervised cross-modal pretext task or trained with labels for a specific downstream perception task.

11. The method of claim 1, wherein the radar-camera rig is equipped with multiple radars and/or multiple cameras, and wherein calibration estimates the translation and rotation of the multiple radars and cameras with respect to one world frame.

12. The method of claim 1, wherein the neural network ingests data entries from a plurality of devices within the rig along with their geometric embeddings.

13. The method of claim 1, wherein the intrinsic matrix of the rig camera is either obtained from the metadata fields of its image data or estimated using off-the-shelf camera calibration techniques.

14. The method of claim 1, wherein the millimetre-wave imaging radar within the rig scans the environment with a frequency modulated continuous wave (FMCW) or orthogonal frequency-division multiplexing (OFDM) signals in a high-frequency band between 20 gigahertz (GHz) and 81 GHZ, and processes the signals reflected off objects using FMCW or OFDM demodulation to generate 3-D radar point clouds.

15. The method of claim 14, wherein the millimetre-wave imaging radar within the rig has a subsystem for estimating an object's range, azimuth, and elevation for localisation, e.g., by means of FFT-based or super-resolution subspace techniques.

16. The method of claim 6, wherein the meta-surface tag uses antenna impedance or mechanical means for coding the electromagnetic energy impinging on it.

17. The method of claim 1, wherein the neural network model may ingest more than one radar input such as range-azimuth-elevation voxels and range-Doppler maps.

18. An apparatus comprising:
a radar-camera rig;
a computing subsystem configured to receive data entries from radar and camera in the radar-camera rig;
means for calibrating the radar with respect to the camera to produce estimated geometric information;
means for calculating geometric embeddings based on the estimated geometric information;
means for training the network based on a dataset of data entries and their geometric embeddings to iteratively learn using a loss function;
means for obtaining perception groundtruth in-situ after deployment;
means for performing inferences and measuring deviation from groundtruth; and
means for adjusting the geometric information to more closely match groundtruth, thereby enhancing the performance of the neural network.

19. An apparatus of claim 18 comprising means for using a tagged 3D structure to establish sparse radar-camera correspondences for estimating the translation and rotation of one device with respect to the other within the radar-camera rig.

20. A computer readable medium on which is stored instructions for executing a neural network model trained according to a method comprising:
receiving data entries from a radar and a camera in a radar-camera rig;
calibrating the radar-camera rig using a 3-D structure that enables estimating geometric information that describes position and orientation of one device with respect to the other;
calculating geometric embeddings based on the estimated geometric information;
feeding the data entries received along with the geometric embeddings to a neural network;
training the network based on a dataset of data entries and the geometric embeddings to iteratively learn using a loss function;
freezing the neural network and deploying the neural network for perception inferences;
obtaining perception groundtruth in-situ after deployment;
performing inferences and measuring deviation from groundtruth; and
finely adjusting the geometric information and in turn the geometric embeddings to give perception inferences that more closely match groundtruth, thereby enhancing the performance of the neural network.
